(19) United States
(12) Patent Application Publication
(10) Pub. No.: US 2006/0024532 A1
(43) Pub. Date: Feb. 2, 2006

(54) Method of producing magnetic recording medium, magnetic recording medium and magnetic storage apparatus

(75) Inventors: Reiko Murao, Higashine (JP); Kenji Sato, Higashine (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/993,071

(22) Filed: Nov. 19, 2004

(30) Foreign Application Priority Data
Jul. 27, 2004 (JP) 2004-218914

(51) Int. Cl. B05D 5/12; G11B 5/66

(52) U.S. Cl. 428/832.1; 427/128

(57) ABSTRACT

A method of producing a magnetic recording medium having a recording layer that is magnetized in a recording direction to record information in the recording layer, includes forming a seed layer made of an amorphous CoW or an amorphous CoW alloy material on a substrate surface, forming an underlayer on the seed layer, and forming the recording layer on the underlayer. The forming of the seed layer includes arranging a target to confront the substrate surface, sputtering with respect to the substrate surface sputtering particles of the target from one of two sides partitioned by a first plane that is formed by the recording direction and a substrate normal which is normal to the substrate surface in a predetermined direction inclined with respect to the substrate normal, and oxidizing a surface of the seed layer on which the underlayer is formed.

### BACKGROUND OF THE INVENTION

This application claims the benefit of a Japanese Patent Application No. 2004-218914 filed Jul. 27, 2004, in the Japanese Patent Office, the disclosure of which is hereby incorporated by reference.

1. Field of the Invention

The present invention generally relates to methods of producing magnetic recording medium, magnetic recording media and magnetic storage apparatuses, and more particularly to a method of producing a magnetic recording medium for use in longitudinal magnetic recording (or in-plane magnetic recording), a magnetic recording medium produced by such a method, and a magnetic storage apparatus using such a magnetic recording medium.

2. Description of the Related Art

Recently, storage capacities of magnetic storage apparatuses used in personal computers and dynamic image recording apparatuses for home use have increased considerably. For example, there are magnetic disk drives, mainly for dynamic image recording, which have a storage capacity exceeding 100 GB. It is expected that the demands to further increase the storage capacity and to further reduce the cost of magnetic disk drives will continue to increase.

Presently, in magnetic disk drives for use in longitudinal magnetic recording (or in-plane magnetic recording), active research is being made to increase the recording density so as to realize the large storage capacity. Improvements in both the signal-to-noise ratio (SNR) of magnetic disks and the sensitivity of magnetic heads have led to an in-plane recording density exceeding 100 Gbits/in².

A magnetic disk is produced by successively forming an underlayer, a magnetic recording layer and a protection layer on a substrate. In order to improve the electromagnetic conversion characteristics of the magnetic disk, such as the resolution, non linear transition shift (NLTS) and SNR, there is a technique that subjects the substrate surface to a mechanical texturing in a circumferential direction of the magnetic disk. By providing the mechanical texturing, axes of easy magnetization of a CoCr alloy forming the magnetic recording layer become aligned in the circumferential direction, to thereby improve the coercivity and the orientation ratio (OR) in the circumferential direction. This technique can achieve a high recording density, but because the substrate surface is subjected to the mechanical texturing, the shape of the textured substrate surface is inherited to the surface shape of the magnetic disk. In other words, the surface roughness of the disk surface increases due to the mechanical texturing of the substrate surface. In the case where the disk surface has the increased surface roughness, it is difficult to improve the electromagnetic conversion characteristics of the magnetic disk by reducing the distance between a magnetic head and the disk surface, and there is a limit to increasing the recording density according to this approach.

In order to improve the orientation of the axes of easy magnetization of the magnetic layer in the circumferential direction, a Japanese Laid-Open Patent Application No. 8-7250 proposes a method of depositing a Cr underlayer and the magnetic layer at an inclination. Further, Japanese Laid-Open Patent Applications No. 2002-203312 and No. 2002-260218 propose methods of sputtering an underlayer at an inclination between the substrate and the underlayer.

However, the conventional methods cannot simultaneously realize a smooth disk surface and improved orientation of the magnetic recording layer in the circumferential direction, so as to enable further improvement of the high recording density.

### SUMMARY OF THE INVENTION

Accordingly, it is a general object of the present invention to provide a novel and useful method of producing magnetic recording medium, magnetic recording medium and magnetic storage apparatus, in which the problems described above are suppressed.

Another and more specific object of the present invention is to provide a method of producing magnetic recording medium, a magnetic recording medium and a magnetic storage apparatus, which can simultaneously realize a smooth magnetic recording medium surface and improved orientation of axes of easy magnetization of a magnetic recording layer in a direction in which tracks extend, so as to enable further improvement of the high recording density.

Still another object of the present invention is to provide a method of producing a magnetic recording medium having a recording layer that is magnetized in a recording direction to record information in the recording layer, comprising forming a seed layer, made of an amorphous CoW or an amorphous CoW alloy material, on a substrate surface; forming an underlayer on the seed layer; and forming the recording layer on the underlayer, wherein the forming the seed layer comprises arranging a target to confront the substrate surface; sputtering, with respect to the substrate surface, sputtering particles of the target from one of two sides partitioned by a first plane that is formed by the recording direction and a substrate normal which is normal to the substrate surface in a predetermined direction inclined with respect to the substrate normal; and oxidizing a surface of the seed layer on which the underlayer is formed. According to the method of producing the magnetic recording medium of the present invention, it is possible to improve the orientation of axes of easy magnetization of the recording layer in a direction in which tracks extend (circumferential direction in the case of a magnetic disk), and to improve the static magnetic characteristics and the SNR. Further, it is possible to make the surface of the magnetic recording medium smooth because the orientation of axes of easy magnetization of the recording layer can be improved without having to provide texturing on the substrate surface. Therefore, it is possible to realize a high recording density.

A further object of the present invention is to provide a magnetic recording medium comprising a seed layer, made of an amorphous CoW or an amorphous CoW alloy material, provided on a substrate surface and having an oxidized surface; an underlayer provided on the seed layer; and a recording layer provided on the underlayer, the recording layer being magnetized in a recording direction to record information in the recording layer, wherein the seed layer is formed by crystal grains having an orientation inclined towards one of two sides partitioned by a plane that is formed by the recording direction and a substrate normal which is normal to the substrate surface. According to the magnetic recording medium of the present invention, it is possible to improve the orientation of axes of easy magnetization of the recording layer in a direction in which tracks extend (circumferential direction in the case of a magnetic disk), and to improve the static magnetic characteristics and the SNR. Further, it is possible to make the surface of the magnetic recording medium smooth because the orientation of axes of easy magnetization of the recording layer can be improved without having to provide texturing on the substrate surface. Therefore, it is possible to realize a high recording density.

Another object of the present invention is to provide a magnetic storage apparatus comprising at least one magnetic recording medium; and a head to record and/or reproduce information to and/or from the magnetic recording medium, wherein the magnetic recording medium comprises a seed layer made of an amorphous CoW or an amorphous CoW alloy material provided on a substrate surface and having an oxidized surface, an underlayer provided on the seed layer, and a recording layer provided on the underlayer, the recording layer being magnetized in a recording direction to record information in the recording layer, and the seed layer is formed by crystal grains having an orientation inclined towards one of two sides partitioned by a plane that is formed by the recording direction and a substrate normal which is normal to the substrate surface. According to the magnetic storage apparatus of the present invention, it is possible to improve the orientation of axes of easy magnetization of the recording layer in a direction in which tracks extend (circumferential direction in the case of a magnetic disk), and to improve the static magnetic characteristics and the SNR. Further, it is possible to make the surface of the magnetic recording medium smooth because the orientation of axes of easy magnetization of the recording layer can be improved without having to provide texturing on the substrate surface. Therefore, it is possible to realize a high recording density.

Of course, the mechanical texturing may be provided on the substrate surface to further improve the orientation of the axes of easy magnetization of the recording layer, to further increase the high recording density. In this case, it is possible to simultaneously realize a smooth medium surface and improved orientation of the recording layer by making the texturing of the substrate surface have a surface roughness that is small compared to the conventional mechanical texturing.

Other objects and further features of the present invention will be apparent from the following detailed description when read in conjunction with the accompanying drawings.

### BRIEF DESCRIPTION OF THE DRAWINGS

FIG. 1 is a cross sectional view showing an embodiment of a magnetic recording medium according to the present invention that is produced by an embodiment of a method of producing the magnetic recording medium according to the present invention;

FIGS. 2A through 2D are diagrams showing various production stages for explaining the embodiment of the method;

FIG. 3 is a perspective view generally showing an important part of a sputtering apparatus;

FIG. 4 is a cross sectional view showing an important part of the sputtering apparatus shown in FIG. 3;

FIG. 5 is a diagram showing characteristics of magnetic disks according to embodiment samples and comparison examples;

FIG. 6 is a diagram showing characteristics of magnetic disks according to an embodiment sample and a comparison example; and

FIG. 7 is a plan view showing an important part of an embodiment of a magnetic storage apparatus according to the present invention.

### DESCRIPTION OF THE PREFERRED EMBODIMENTS

The present inventors have found through studies and experimentation of various seed layer materials and seed layer forming conditions, that an amorphous seed layer suited for realizing a high recording density in a magnetic recording medium can be formed by an inclined sputtering of nonmagnetic CoW or a nonmagnetic CoW alloy material on a substrate surface, and that the surface of this seed layer may be oxidized, so that orientation of magnetic grains of a recording layer provided above the seed layer is improved. More particularly, the provision of this seed layer aligns the axes of easy magnetization of the magnetic grains of the recording layer in a recording direction of the magnetic recording medium, that is, in a direction in which tracks extend (circumferential direction in the case of a magnetic disk). The present inventors also found that by this arrangement, an orientation Hcc/Hcr of the magnetic recording medium (that is, the recording layer) improves, where Hcc denotes a circumferential coercivity of the recording layer and Hcr denotes a radial direction coercivity of the recording layer.

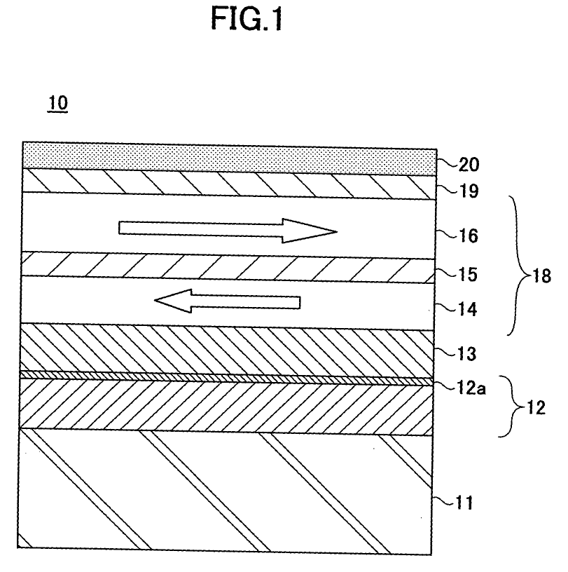

FIG. 1 is a cross sectional view showing an embodiment of a magnetic recording medium according to the present invention that is produced by an embodiment of a method of producing the magnetic recording medium according to the present invention.

A magnetic recording medium 10 shown in FIG. 1 has a disk substrate 11, and a seed layer 12, an underlayer 13, a magnetic recording layer 18, a protection layer 19 and a lubricant layer 20 that are successively formed on the disk substrate 11. The seed layer 12 has an oxidized surface 12a. The recording layer 18 is formed by a first magnetic layer 14, a nonmagnetic coupling layer 15 and a second magnetic layer 16. The recording layer 18 has an exchange-coupled structure in which the first and second magnetic layers 14 and 16 are antiferromagnetically exchange-coupled via the nonmagnetic coupling layer 15. In a state where no external magnetic field is applied on the magnetic recording medium 10, magnetizations of the first and second magnetic layers 14 and 16, oriented in an in-plane direction, are mutually antiparallel.

This embodiment is characterized by the seed layer 12. By the provision of this seed layer 12, axes of easy magnetization of crystal grains forming the recording layer 18 are oriented in a circumferential direction of the disk substrate 11, even if no mechanical texturing is provided on the surface of the disk substrate 11 and/or the seed layer 12. As a result, thr circumferential coercivity Hcc and the orientation Hcc/Hcr improve, where Hcr denotes the radial direction coercivity.

For example, the disk substrate 11 is made up of a plastic substrate, a glass substrate, a NiP-plated Al alloy substrate, a Si substrate or the like having a disk-shape. The surface of the disk substrate 11 may or may not be textured. For example, the surface of the plastic substrate, the glass substrate or the NiP-plated Al alloy substrate may be textured by being subjected to a mechanical texturing or a laser texturing in the circumferential direction, that is, in a longitudinal direction of tracks formed on the magnetic recording medium 10. The orientation of the recording layer 18 in the circumferential direction is improved by the provision of the seed layer 12. But by providing the texturing on the surface of the disk substrate 11, it is possible to further improve the orientation of the recording layer 18 in the circumferential direction. The average surface roughness of the texturing when measured using an atomic force microscope (AFM) is preferably in a range of 0.2 nm to 0.5 nm. If the average surface roughness is greater than 0.5 nm, the surface roughness of the surface of the magnetic recording medium 10 increases, to thereby prevent a sufficient increase of the recording density. On the other hand, if the average surface roughness is less than 0.2 nm, the desirable effects of the texturing in the circumferential direction are reduced.

The seed layer 12 is made of an amorphous nonmagnetic CoW alloy material. The seed layer 12 is formed by an inclined (or oblique) sputtering which will be described later, and the surface of the seed layer 12 is oxidized to form the oxidized surface 12a.

The CoW alloy material, when in the amorphous state, improves the orientation of the recording layer 18 in the circumferential direction, as will be described later in conjunction with embodiment samples. For example, the W-content (or W concentration) in the CoW alloy material that makes the CoW alloy material amorphous is 30 atomic percent (at. %) to 60 at. %. The CoW alloy material may be CoW or CoW-Y, where Y=B, N or an alloy thereof.

The thickness of the seed layer 12 is set in a range of 5 nm to 30 nm. From the point of view of obtaining satisfactory electromagnetic conversion characteristics of the magnetic recording medium 10, the thickness of the seed layer 12 is preferably set in a range of 5 nm to 15 nm if the surface of the disk substrate 11 or another seed layer arbitrarily provided under the seed layer 12 is mechanically textured, for example, and is preferably set in a range of 5 nm to 25 nm if no mechanical texturing is applied to the surface of the disk substrate 11 or the other seed layer arbitrarily provided under the seed layer 12.

The oxidized surface 12a of the seed layer 12 does not need to cover the entire top surface of the seed layer 12, and may be provided in the form of islands. In the case where the seed layer 12 is made of CoW, it may be regarded that the CoW is in an oxidized state or, Co or W is in a selectively oxidized state, at the oxidized surface 12a.

A layer (not shown) made of a material similar to that used for the seed layer 12 may be formed underneath the seed layer 12 by perpendicular sputtering. For example, this layer has a thickness in a range of 5 nm to 30 nm. A satisfactory initial growth of the seed layer 12 occurs by the provision of this layer, which in turn further improves the orientation of the recording layer 18 in the circumferential direction, to thereby enable the thickness of the seed layer 12 to be reduced.

For example, the underlayer 13 is made of Cr or a Cr-X alloy, where X=Mo, W, V, B, Mo or alloys thereof. The underlayer 13 is formed by crystal grains having a uniform crystal grain diameter grown on the oxidized surface 12a of the seed layer 12, and the (001) or (112) face is oriented in a direction suitable for in-plane orientation. The underlayer 13 may be made up of a stacked structure that includes a plurality of stacked layers made of Cr or the Cr-X alloy. By using the stacked structure for the underlayer 13, it is possible to suppress the crystal grains of the underlayer 13 from becoming large, and to suppress the crystal grains of the first and second magnetic layers 14 and 16 from becoming large. In addition, by using the stacked structure for the underlayer 13, it is also possible to improve the orientation ratio (OR) of the recording layer 18. In the case where the seed layer 12 is made of CoW, the stacked structure for the underlayer 13 is preferably made up of a Cr layer and a CrMo layer.

The first magnetic layer 14 has a thickness in a range of 0.5 nm to 20 nm, and is made of Co, Ni, Fe, Co alloy, Ni alloy, Fe alloy or the like, for example. CoCrTa and CoCrPt are preferable, and a CoCrPt-M alloy may be used as the Co alloy forming the first magnetic layer 14, where M=B, Mo, Nb, Ta, W, Cu or alloys thereof. The first magnetic layer 14 may be made up of a stacked structure that includes a plurality of stacked layers made of Co, Ni, Fe, Co alloy, Ni alloy, Fe alloy or the like. By using the stacked structure for the first magnetic layer 14, it is possible to improve the orientation of the crystal grains of the second magnetic layer 16.

For example, the nonmagnetic coupling layer 15 is made of Ru, Rh, Ir, Ru alloy, Rh alloy, Ir alloy or the like. Rh and Ir have an fcc structure, while Ru has a hcp structure. Ru has a lattice constant a=0.27 nm which is close to a lattice constant a=0.25 nm of the CoCrPt alloy that is used for the first magnetic layer 14 and the second magnetic layer 16, and thus, Ru and the Ru alloy are preferably used for the nonmagnetic coupling layer 15 when the CoCrPt alloy is used for the first and second magnetic layers 14 and 16. The Ru alloy may include at least one of Co, Cr, Fe, Ni, Mn or alloys thereof.

In addition, the thickness of the nonmagnetic coupling layer 15 is in a range of 0.4 nm to 1.5 nm, and preferably in a range of 0.6 nm to 0.9 nm. Depending on the Ru-content within the Ru alloy in the case of the nonmagnetic coupling layer 15 made of the Ru alloy, the thickness of the nonmagnetic coupling layer 15 may be in a range of 0.8 nm to 1.4 nm. The first and second magnetic layers 14 and 16 are exchange-coupled via the nonmagnetic coupling layer 15, and by setting the thickness of the nonmagnetic coupling layer 15 within the above described range, the first and second magnetic layers 14 and 16 become antiferromagnetically coupled. In a state where no external magnetic field is applied to the magnetic recording medium 10, magnetizations of the first and second magnetic layers 14 and 16 become mutually antiparallel as indicated arrows in FIG. 1. The exchange coupling state of the first and second magnetic layers 14 and 16 depends on the thickness of the nonmagnetic coupling layer 15, and the magnetizations of the first and second magnetic layers 14 and 16 reciprocate between the mutually antiparallel state and a mutually parallel state depending on the thickness of the nonmagnetic coupling layer 15. It is particularly preferable to set the thickness of the nonmagnetic coupling layer 15 to match a first antiferromagnetic peak where the magnetizations of the first and second magnetic layers 14 and 16 become mutually antiparallel and the thickness of the nonmagnetic coupling layer 15 is the thinnest.

The second magnetic layer 16 has a thickness in a range of 5 nm to 20 nm, and is made of Co, Ni, Fe, Co alloy, Ni alloy, Fe alloy and the like, similarly as in the case of the first magnetic layer 14. It is preferable that a product of a remanent magnetization Mr1 and a thickness t1 of the first magnetic layer 14 (that is, a remanent magnetization and thickness product Mr1×t1) and a product of a remanent magnetization Mr2 and a thickness t2 of the second magnetic layer 16 (that is, a remanent magnetization and thickness product Mr2×t2) satisfy a relationship (Mr1×t1)<(Mr2×t2). The second magnetic layer 16 has the magnetization in the same direction as the total remanent magnetization of the magnetic recording medium 10, and information can be written accurately in the second magnetic layer 16 in correspondence with switching positions of the recording magnetic field of the magnetic head. Of course, the remanent magnetization and thickness product Mr1×t1 and the remanent magnetization and thickness product Mr2×t2 may satisfy a relationship (Mr1×t1)>(Mr2×t2). As the thicknesses of the first and second magnetic layers 14 and 16 are reduced, the above described problems encountered at the time of the recording are suppressed.

The first magnetic layer 14 and the second magnetic layer 16 may have different compositions. For example, the material used for the second magnetic layer 16 is selected from materials which result in a larger anisotropic magnetic field than the material used for the first magnetic layer 14. The alloy used for the second magnetic layer 16 may be added with Pt while no Pt is added for the alloy used for the first magnetic layer 16 or, the Pt-content (in at. %) of the alloy may be larger for the second magnetic layer 16 than the first magnetic layer 14. For example, when using CoCr alloys for the first and the second magnetic layers 14 and 16, only the second magnetic layer 16 may be added with Pt. On the other hand, when using CoCrPt alloys for the first and second magnetic layers 14 and 16, CoCrPt₈ may be used for the first magnetic layer 14 and CoCrPt₁₂ may be used for the second magnetic layer 16, where the numeral affixed to Pt denotes atomic percent (at. %). The atomic percent (at. %) of other elements are indicated similarly in this specification.

Therefore, in the recording layer 18, the first and second magnetic layers 14 and 16 are antiferromagnetically exchange-coupled via the nonmagnetic coupling layer 15. Hence, the apparent volume of the recording layer 18 becomes substantially equal to a sum of the volumes of the first and second magnetic layers 14 and 16, which is large compared to the case where the recording layer is formed by a single-layer structure, to thereby improve the thermal stability of the magnetizations (or written bits).

The recording layer 18 may be formed by a stacked structure having more than 2 magnetic layers. In this case, the magnetic layers of the stacked structure are exchange-coupled, and at least two magnetic layers are antiferromagnetically exchange-coupled.

Of course, the recording layer 18 may be formed by a single magnetic layer which does not employ the exchange coupling, similarly as in the case of the conventional magnetic recording media.

The protection layer 19 has a thickness in a range of 0.5 nm to 10 nm, and preferably in a range of 0.5 nm to 5 nm, and is made of Diamond-Like Carbon (DLC), carbon nitride, amorphous carbon and the like, for example.

The lubricant layer 20 is made of an organic liquid lubricant having perfluoropolyether as a main chain and —OH, phenyl, benzene ring or the like as the terminal functional group. More particularly, ZDol manufactured by Monte Fluos (terminal functional group: —OH), AM3001 manufactured by Ausimonoto (terminal functional group: benzene ring), Z25 manufactured by Monte Fluos, and the like, with a thickness in a range of 0.5 nm to 3.0 nm, may be used for the lubricant layer 20. The lubricant may be appropriately selected depending on the material used for the protection layer 19. Depending on the kind of protection layer 19 used, the lubricant layer 20 may be omitted.

Another seed layer (not shown) may be provided between the disk substrate 11 and the seed layer 12. This other seed layer may be made of a nonmagnetic material such as NiP and CrTi. The surface of this other seed layer may or may not be textured. When using an amorphous material such as NiP for this other seed layer, it is preferable that the surface of this other seed layer is oxidized. This other seed layer made of NiP, that is preferably oxidized, improves the c-axis in-plane orientation of the first and second magnetic layers 14 and 16. Of course, suitable materials other than NiP may be used to improve the c-axis orientation of the first and second magnetic layers 14 and 16.

A nonmagnetic intermediate layer (not shown) may be provided between the underlayer 13 and the first magnetic layer 14. The nonmagnetic intermediate layer may be made of a nonmagnetic alloy having an hcp structure, such as a CoCr alloy added with an element or an alloy M1, where M1=Pt, B, Mo, Nb, Ta, W, Cu or alloys thereof, and has a thickness in a range of 1 nm to 5 nm, for example. The nonmagnetic intermediate layer grows by inheriting the crystallinity and crystal grain size of the underlayer 13, and improves the crystallinity of the first and second magnetic layers 14 and 16 which are epitaxially grown above the nonmagnetic intermediate layer. In addition, the nonmagnetic intermediate layer reduces the grain size deviation width in the distribution of the crystal grain (magnetic grain) sizes, and promotes the orientation of the c-axis in the in-plane direction. The nonmagnetic intermediate layer may be formed by a stacked structure that is made up of a plurality of layers made of the nonmagnetic alloys described above, and in this case, it is possible to further improve the crystal orientations of the first and second magnetic layers 14 and 16. The lattice constant of the nonmagnetic intermediate layer may be set to differ by several % with respect to the lattice constant of the first magnetic layer 14 or the second magnetic layer 16, so as to generate an internal stress in the in-plane direction at the interface of the nonmagnetic intermediate layer and the first magnetic layer 14 or, within the first magnetic layer 14, so as to increase the coercivity of the first magnetic layer 14.

Next, a description will be given of this embodiment of the method of producing the magnetic recording medium according to the present invention.

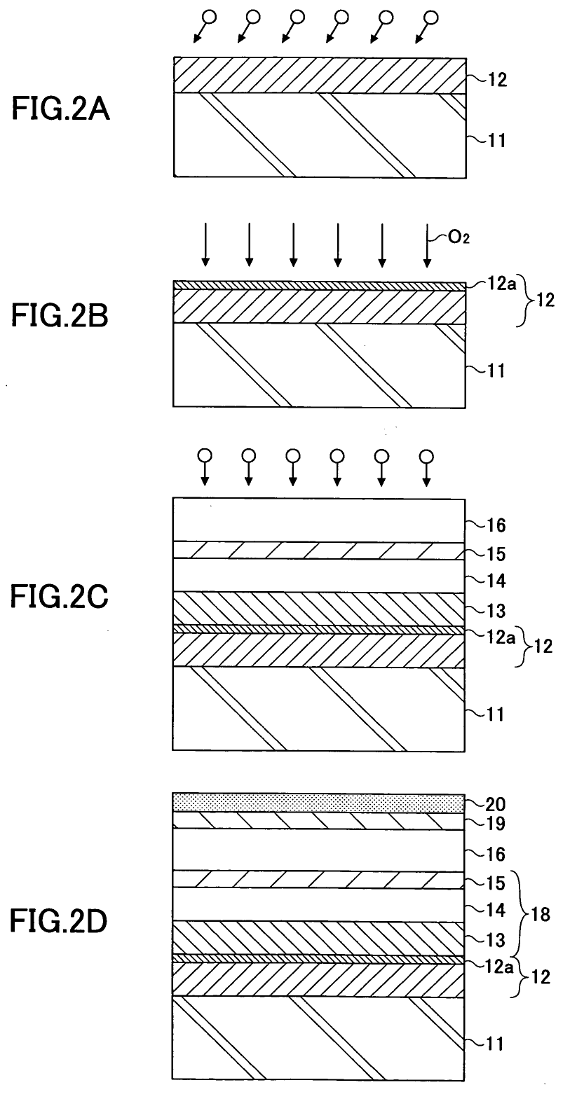

FIGS. 2A through 2D are cross sectional views showing various production stages for explaining this embodiment of the method of producing the magnetic recording medium according to the present invention.

In a step shown in FIG. 2A, after the substrate surface of the disk substrate 11 is cleaned and dried, the disk substrate 11 is heated to a temperature in a range of 170° C. to 200° C., for example, within a vacuum atmosphere by use of a pyrolytic boron nitride (PBN) heater, for example.

In addition, in the step shown in FIG. 2A, a sputtering apparatus is used to form the seed layer 12 on the substrate surface of the disk substrate 11 by the inclined sputtering. The inside of the chamber is once exhausted to a vacuum of 10⁻⁵ Pa or less, and an Ar gas pressure is set to 0.67 Pa and the power is set to 1 kW, so as to form the seed layer 12 to a thickness of 5 nm, for example, by the D.C. magnetron sputtering with a discharge time of 4 seconds, for example. The inclined sputtering, which forms an important part of this embodiment, is carried out in the following manner.

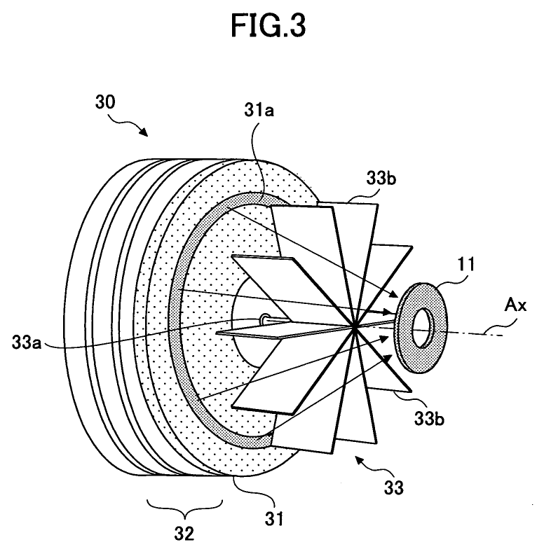

FIG. 3 is a perspective view generally showing an important part of the sputtering apparatus. FIG. 3 shows the inside of a chamber (not shown) of a sputtering apparatus 30. In the sputtering apparatus 30, a ring-shaped sputtering target 31 made of the seed layer material is arranged so that a sputtering surface of the sputtering target 31 confronts the substrate surface of the disk substrate 11. A magnet unit 32 is arranged on a rear of the sputtering target 31. A rotary shield part 33 is arranged between the disk substrate 11 and the sputtering target 31. Although not shown in FIG. 3, the sputtering apparatus 30 further includes an exhaust system for exhausting the inside of the chamber, a gas introducing system for introducing gasses into the chamber, and a power supply for supplying discharging power to the sputtering target 31.

The sputtering apparatus 30 traps discharge plasma including electrons and gas ions, such as Ar ions, in a vicinity of the sputtering surface of the sputtering target 31, along the lines of magnetic force of the magnet unit 32. The Ar ions cause the target material at a predetermined region on the target surface of the sputtering target 31 to be sputtered onto the substrate surface of the disk substrate 11 as sputtered particles. The sputtered particles move approximately linearly from the sputtering target 31 towards the substrate surface to form the seed layer 12. An erosion region 31a is formed in the predetermined region of the target surface of the sputtering target 31 where the sputtering particles originated.

The rotary shield part 33 has a rotary shaft 33a provided coaxially to the disk substrate 11, the sputtering target 31 and the magnet unit 32. The rotary shield part 33 also has a plurality of shield plates 33b that extend radially outwards from the rotary shaft 33a. Surfaces of the shield plates 33b are perpendicular to the target surface of the sputtering target 31.

The shield plates 33b are arranged at equal angular intervals around the rotary shaft 33a. A length of each shield plate 33b in the radial direction, from a center axis Ax of the rotary shaft 33a to the outer peripheral edge of the shield plate 33b, is approximately the same as or is greater than the radius of the disk substrate 11. Hence, the sputtering particles moving in the radial direction of the disk substrate 11 reach the substrate surface of the disk substrate 11 more easily than the sputtering particles moving in the circumferential direction of the disk substrate 11, so as to suppress the sputtering particles from moving in a direction away from the radial direction to become deposited with an inclination on the substrate surface. In addition, the arrangement and dimensions of the shield plates 33b also prevent the sputtering particles from passing the central portion of the disk substrate 11 to become deposited on the opposite surface of the disk substrate 11. Accordingly, crystal grains having small deviations in the growth direction are grown on the substrate surface of the disk substrate 11 to form the seed layer 12.

The length of each shield plate 33b in the radial direction may be smaller than the radius of the disk substrate 11. In this case, it is still possible to prevent the sputtering particles from passing the central portion of the disk substrate 11 to become deposited on the opposite surface of the disk substrate 11.

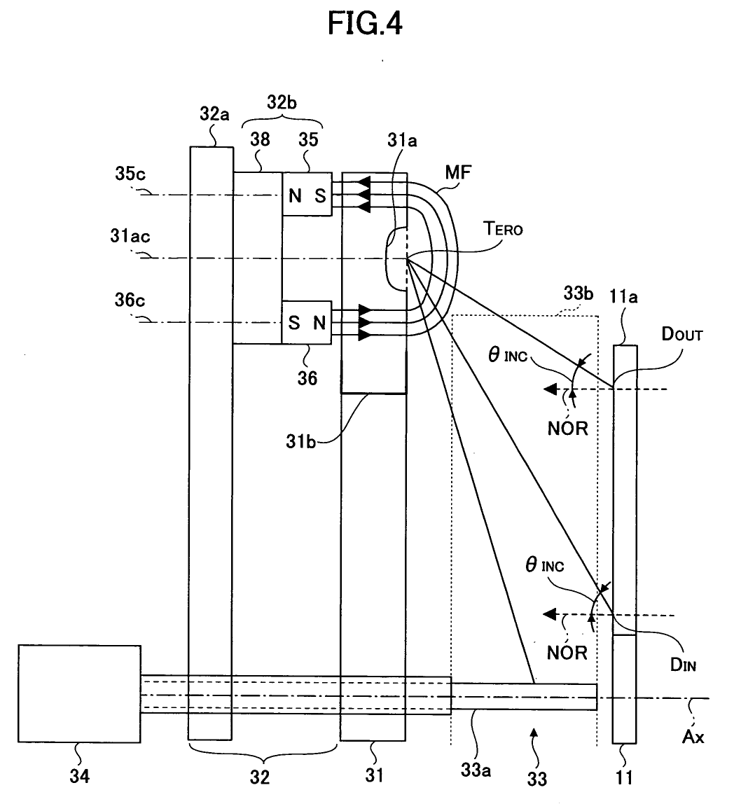

The rotary shield part 33 is made of an insulator material or, the surface of the rotary shield part 33 is made of an insulator material, so as to prevent a discharge plasma distribution and a potential distribution within the chamber from being affected by the rotary shield part 33. The rotary shaft 33a of the rotary shield part 33 is connected to a rotary driving part 34 (shown in FIG. 4 which will be described later) that is provided on the rear of the sputtering target 31, and the rotary shield part 33 is rotated by the rotary driving part 34 at a rotational speed of 60 rpm, for example. By rotating the rotary shield part 33, the thickness of the seed layer 12 can be made uniform, and the sputtering particles will adhere uniformly on the shield plates 33b so that the maintenance interval of the shield plates 33b can be extended. Of course, the rotary shield part 33 does not necessarily have to be rotated.

FIG. 4 is a cross sectional view showing an important part of the sputtering apparatus 30 shown in FIG. 3. FIG. 4 is a cross sectional view cut along a plane passing the center axis Ax which approximately matches the center axes of the disk substrate 11, the sputtering target 31 and the magnet unit 32 shown in FIG. 3. Since the structures above and below the center axis Ax are symmetrical about the center axis Ax, only the upper structure is shown in FIG. 4.

As shown in FIG. 4, the magnet unit 32 includes a magnet base 32a and a magnet part 32b. The magnet part 32b is made up of an outer ring-shaped magnet 35, an inner ring-shaped magnet 36 and a yoke 38. The outer and inner ring-shaped magnets 35 and 36 are formed by permanent magnets that are magnetized in the direction of the arrows shown in FIG. 4. The yoke 38 is made of a soft magnetic material. Lines of magnetic force (hereinafter simply referred to as lines MF) of the magnet part 32b extend from the N-pole of the inner ring-shaped magnet 36, pass through the sputtering target 31, turn and pass through the sputtering target 31 again, and return to the S-pole of the outer ring-shaped magnet 35. Ar ions forming the discharge plasma trapped along the lines MF cause the sputtering particles to be discharged from the sputtering surface of the sputtering target 31, and cause the erosion region 31a to be formed on the sputtering surface.

The outer and inner ring-shaped magnets 35 and 36 may be formed by electromagnets.

In this embodiment, the magnet part 32b is arranged so that the erosion region 31a of the sputtering target 31 is located on the outer side of an outer peripheral edge 11a of the disk substrate 11, to cause the sputtering particles to move towards the disk substrate 11 at an inclination from the outer peripheral edge 11a to the inner peripheral side, that is, to cause the sputtering particles to become incident to the substrate surface at an inclination angle θ_{INC}. An inner peripheral edge 31b of the sputtering target 31 is located on the inner side of the outer peripheral edge 11a of the disk substrate 11 in FIG. 4, but the inner peripheral edge 31b may be located on the outer side of the outer peripheral edge 11a.

The inclination angle θ_{INC} of the sputtering particles with respect to the disk substrate 11 is defined as an angle formed between a substrate normal NOR with respect to the substrate surface of the disk substrate 11 and an imaginary incident line that connects a center T_{ERO} of the erosion region 31a and a depositing position in a track region on the substrate surface. The track region is defined as the region between an inner (or innermost) peripheral position D_{IN} and an outer (or outermost) peripheral position D_{OUT}. The center T_{ERO} of the erosion region 31a is defined as an intersection of the sputtering surface of the sputtering target 31 before the sputtering starts and a bisector 35ac between a centerline 35c of the outer ring-shaped magnet 35 and a centerline 36c of the inner ring-shaped magnet 36.

Since the shield plates 33b are provided in the vicinity of the center axis Ax, the sputtering particles moving in the radial direction of the disk substrate 11 so as to pass beyond the center axis Ax will be blocked by the shield plates 33b. Hence, such sputtering particles adhere on the shield plates 33b and are prevented from passing beyond the center axis Ax and reaching the disk substrate 11.

In a step shown in FIG. 2B, an oxidation process employing natural oxidation is carried out. In other words, the surface of the seed layer 12 is exposed to an oxygen-containing atmosphere within the chamber. The oxygen-containing atmosphere may be obtained by simultaneously supplying to the chamber a noble gas such as Ar gas and oxygen gas, setting the oxygen gas flow rate to 10 sccm to 30 sccm, the pressure to 0.06 Pa to 0.18 Pa, and the processing time to 2 seconds to 4 seconds, for example.

In the case of the disk substrate 11 made of glass and formed with the seed layer 12, the disk substrate 11 may be heated or cooled under vacuum or in a noble gas environment prior to exposing the surface of the seed layer 12 to the oxygen-containing atmosphere, so as to control the thickness of the oxidized surface 12a or, to control the in-plane distribution and the like of the oxidized surface 12a if the oxidized surface 12a is provided in the form of islands.

Next, in a step shown in FIG. 2C, the underlayer 13, the first magnetic layer 14, the nonmagnetic coupling layer 15 and the second magnetic layer 16 which are made of the materials described above are successively formed on the seed layer 12 by perpendicular sputtering. The layers 13 through 16 are formed by setting the Ar gas pressure to 0.67 Pa and successively sputtering the layers 13 through 16 by the D.C. magnetron sputtering apparatus so that the sputtering particles reach the substrate surface of the disk substrate 11 at an incident angle that is approximately perpendicular to the substrate surface. The disk substrate 11 may be heated again before forming the first magnetic layer 14 or the nonmagnetic coupling layer 15. The heating temperature of the disk substrate 11 in this case is set to 270° C. or less, and preferably in a range of 200° C. to 240° C.

Next, in a step shown in FIG. 2D, the protection layer 19 made of DLC or the like is formed on the second magnetic layer 16 to a thickness of 3 nm, for example, by sputtering, CVD, FCA or the like. The steps from the substrate heating step shown in FIG. 2A to the protection layer forming step shown in FIG. 2D are carried out within the chamber. Preferably, the disk substrate 11 is not exposed to the outside even during transport while each of these steps are carried out.

The step shown in FIG. 2D may use an organic liquid lubricant that is diluted by a fluoric solvent or the like, and the lubricant layer 20 may be formed to a thickness of 1.5 nm, for example, by pulling, spin-coating, liquid submersion, steam jet and the like. The magnetic recording medium 10 is created in this manner by the above described steps.

According to this embodiment of the method, in the step of forming the seed layer 12, the erosion region 31a of the sputtering target 31 is located on the outer side of the outer peripheral edge 11a of the disk substrate 11, to cause the sputtering particles to move towards the disk substrate 11 at an inclination from the outer peripheral side to the inner peripheral side, that is, to cause the sputtering particles to become incident to the substrate surface at the inclination angle θ_{INC} with respect to the substrate normal NOR. For this reason, the axes of easy magnetization of the recording layer 18 are oriented in the circumferential direction and the crystal orientation of the recording layer 18 in the circumferential direction of the disk substrate 11 is improved, thereby making it is possible to increase the recording density of the magnetic recording medium 10.

In addition, according to this embodiment of the method, the rotary shield part 33 is provided between the disk substrate 11 and the sputtering target 31. Hence, it is possible to prevent the sputtering particles from passing the central portion and/or the outer peripheral portion of the disk substrate 11 to become deposited on the opposite surface of the disk substrate 11. As a result, the sputtering particles are deposited at an inclination towards one direction, that is, the outer peripheral side of the disk substrate 11, and the crystal orientation of the recording layer 18 in the circumferential direction of the disk substrate 11 is further improved.

Next, a description will be given of samples created by this embodiment (hereinafter referred to as embodiment samples).

[First Embodiment Sample Emb-1]

The D.C. magnetron sputtering apparatus 30 was used to form a magnetic disk having the following structure, as the magnetic recording medium 10.

The magnetic disk created includes a glass substrate 11 having a diameter of 65 mm, a Co₆₀W₄₀ seed layer 12 having a thickness of 10 nm with the oxidized surface 12a, a Cr layer having a thickness of 4 nm and a Cr₇₅Mo₂₅ layer having a thickness of 3.5 nm which form the underlayer 13 having a stacked structure, a Co₈₂Cr₁₃Ta₅ first magnetic layer 14 having a thickness of 3.5 nm, a Ru nonmagnetic spacer layer 15 having a thickness of 0.8 nm, a CoCrPt₁₂B₇Cu₄ second magnetic layer 16 having a thickness of 14 nm, a C protection layer 19 having a thickness of 4 nm, and a lubricant layer 20 having a thickness of 1.5 nm.

The glass substrate 11 having a smooth substrate surface was first cleaned, and was then heated to 170° C. within vacuum by the PBN heater prior to forming the AlRu seed layer 12.

Using the sputtering apparatus 30 shown in FIGS. 3 and 4, the erosion region 31a was formed in the Co₆₀W₄₀ sputtering target 31 between a position where the radius is 47.0 mm and a position where the radius is 74.0 mm from the disk center of the glass substrate 11. A center position of the erosion region 31a is located at a radius of 61.0 mm from the disk center of the glass substrate 11. The incident angle θ_{INC} of the sputtering particles from the outer peripheral side of the glass substrate 11 was set to a center incident angle of 37.8 degrees (of a range from 23.0 degrees to 47.8 degrees) at the outer (or outermost) peripheral position D_{OUT} shown in FIG. 4, and to a center incident angle of 50.8 degrees (of a range from 41.2 degrees to 57.2 degrees) at the inner (or innermost) peripheral position D_{IN} shown in FIG. 4. The outer (or outermost) and inner (or innermost) peripheral positions D_{OUT} and D_{IN} are respectively located at radii of 30 mm and 12 mm from the disk center of the glass substrate 11. The Co₆₀W₄₀ seed layer 12 was formed in an Ar gas with an Ar gas pressure of 0.67 Pa. The shield plates 33b of the rotary shield part 33 were provided at an angular interval of 30 degrees along the circumferential direction of the glass substrate 11, and the rotary shield part 31 was rotated at 60 rpm.

The glass substrate 11 having the Co₆₀W₄₀ seed layer 12 formed thereon was then exposed to an oxygen gas atmosphere, at an oxygen gas flow rate of 30 sccm and under a pressure of 0.17 Pa, for a processing time of 4 seconds, so as to oxidize the surface of the Co₆₀W₄₀ seed layer 12 to form the oxidized surface 12a.

The Cr underlayer 13 up to the C protection layer 19 were then successively formed on the oxidized surface 12a of the Co₆₀W₄₀ seed layer 12 by perpendicular sputtering using a D.C. magnetron sputtering apparatus. Then, the lubricant layer 20 was formed on the C protection layer 19 by pulling, so as to create the magnetic disk according to the first embodiment sample Emb-1.

[First Comparison Example Cmp-1]

When forming the Co₆₀W₄₀ seed layer 12 by the perpendicular sputtering, the erosion region 31a of the AlRu sputtering target 31 was set to a position approximately confronting the glass substrate 11. The incident angle θ_{INC} of the sputtering particles from the outer peripheral side of the glass substrate 11 was set to 0. No rotary shield part 33 was used. Otherwise, the first comparison example Cmp-1 was created under the same conditions as the first embodiment sample Emb-1 described above.

[Second Embodiment Sample Emb-2]

The second embodiment sample Cmp-2 was created under the same conditions as the first embodiment sample Emb-1 described above, except that a Co₇₀W₃₀ s puttering target 31 was used in place of the Co₆₀W₄₀ sputtering target 31.

[Third Embodiment Sample Emb-3]

The third embodiment sample Emb-3 was created under the same conditions as the first embodiment sample Emb-1 described above, except that a Co₅₀W₅₀ sputtering target 31 was used in place of the Co₆₀W₄₀ sputtering target 31.

[Second Comparison Example Cmp-2]

The second comparison example Cmp-2 was created under the same conditions as the first comparison example Cmp-1 described above, except that a Co₃₀W₇₀ sputtering target 31 was used in place of the Co₆₀W₄₀ sputtering target 31.

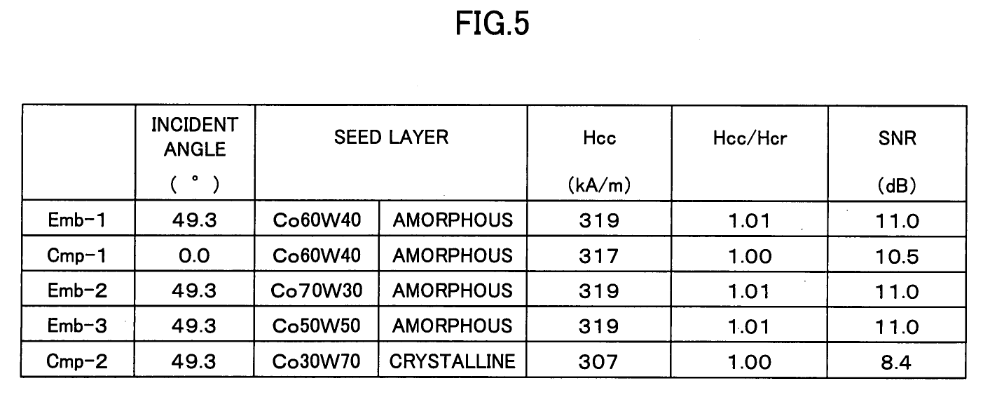

FIG. 5 is a diagram showing characteristics of magnetic disks according to first through third embodiment samples Emb-1 through Emb-3 and first and second comparison examples Cmp-1 and Cmp-2. The crystal states of the seed layers 12 shown in FIG. 5 were obtained by making measurements by a θ-2θ scan using an X-ray diffractometer. When making the measurements, the layers above the seed layer 12, namely, the oxidized surface 12a and the Cr underlayer 13 up to the C protection layer 19, were not formed on the magnetic disks, and the thickness of the seed layer 12 was set to 100 nm. The judgement to determine whether the seed layer 12 is crystalline or amorphous, was made by judging the seed layer 12 to be amorphous if no diffraction ray is recognized.

The magnetic characteristics of the second magnetic layer 16 were obtained using a vibration sample type magnetometer, by applying magnetic fields in the circumferential direction and the radial direction of the magnetic disks and measuring the corresponding hysteresis loops, to obtain the circumferential coercivity Hcc, the orientation Hcc/Hcr, and a circumferential coercivity squareness ratio S* of the magnetic disk (that is, the recording layer 18), where Hcr denotes a radial direction coercivity. When the orientation Hcc/Hcr=1.00, the axis of easy magnetization (or c-axis) of the second magnetic layer 16 is isotropically oriented in-plane, and the larger the orientation Hcc/Hcr, the more the orientation of the axis of easy magnetization in the circumferential direction is promoted.

The SNR was measured using a composite magnetic head which includes an inductive recording element and a Giant Magneto-Resistive (GMR) reproducing element having an element with of 0.16 μm. The SNR (dB) was obtained from 20×log(S/N) based on the average output S (μVₚ₋ₚ) at 414 kFCI and the medium noise N (μVᵣₘₛ).

The measurements for the static magnetic characteristics and the SNR were made at a position located at a measured radius of 14.5 mm. At this measured radius, the center incident angle was 49.3 degrees of the incident angle range of 39.1 degrees to 56.1 degrees, for the first through third embodiment samples Emb-1 through Emb-3 and first and second comparison examples Cmp-1 and Cmp-2.

When the first embodiment sample Emb-1 and the first comparison example Cmp-1 are compared in FIG. 5, it may be seen that the circumferential coercivity Hcc of the first embodiment sample Emb-1 is higher than that of the first comparison example Cmp-1. Further, while the orientation Hcc/Hcr for the first comparison example Cmp-1 is 1.00 and the orientation is isotropic, the orientation Hcc/Hcr for the first embodiment sample Emb-1 is 1.01 and it may be seen that the orientation of the axes of easy magnetization is promoted in the circumferential direction for the first embodiment sample Emb-1. Accordingly, it may be seen that the orientation of the axes of easy magnetization of the recording layer 18 in the circumferential direction is improved for the first embodiment sample Emb-1 which employs the inclined sputtering to form the seed layer 12, compared to that of the first comparison example Cmp-1 which employs the perpendicular sputtering to form the seed layer 12. It may be regarded that the improved orientation of the axes of easy magnetization of the recording layer 18 in the circumferential direction in the case of the first embodiment sample Emb-1 is caused by the surface shape (or configuration) of the seed layer 12 that is formed by the deposited states of the Co and W atoms that are sputtered at the inclined direction. In addition, the SNR is also higher for the first embodiment sample Emb-1 when compared to the first comparison example Cmp-1. The SNR improves for the first embodiment sample Emb-1 due to the improved orientation of the axes of easy magnetization of the recording layer 18 in the circumferential direction, and as a result, a high recording density can be realized.

It may also be seen from FIG. 5 that the orientation of the axes of easy magnetization of the recording layer 18 in the circumferential direction and the SNR are both improved for each of the first through third embodiment samples Emb-1 through Emb-3, compared to those of the second comparison example Cmp-2. It may be regarded that the orientation of the axes of easy magnetization of the recording layer 18 in the circumferential direction is improved for the first through third embodiment samples Emb-1 through Emb-3 because the first through third embodiment samples Emb-1 through Emb-3 have a W-content (or W concentration) of 30 at. % to 50 at. % such that the CoW seed layer 12 is amorphous, while the second comparison example Cmp-2 has a W-content (or W concentration) of 70 at. % and the Co₃₀W₇₀ seed layer 12 is crystalline.

[Fourth Embodiment Sample Emb-4]

The fourth embodiment sample Emb-4 was created under the same conditions as the first embodiment sample Emb-1 described above, except that a mechanical texturing having an average surface roughness Ra of 0.27 nm was formed in the circumferential direction on the substrate surface of the glass substrate 11, using a texturing apparatus.

[Third Comparison Example Cmp-3]

The third comparison example Cmp-3 was created under the same conditions as the first comparison example Cmp-1 described above, except that a mechanical texturing was formed on the substrate surface, similarly to the fourth embodiment sample Emb-4.

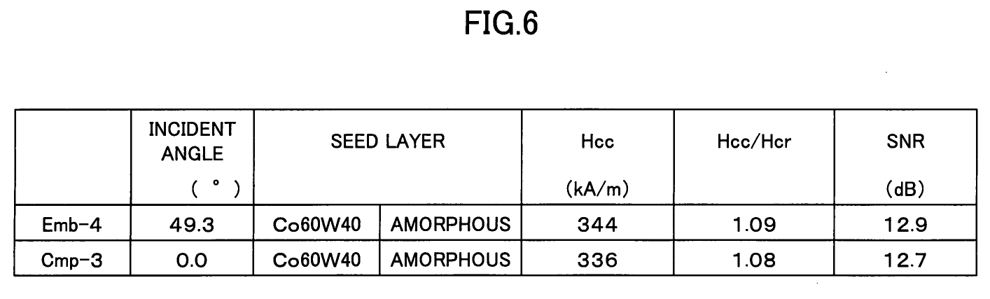

FIG. 6 is a diagram showing characteristics of magnetic disks according to a fourth embodiment sample Emb-4 and a third comparison example Cmp-3. The crystal state, the static magnetic characteristics and the SNR shown in FIG. 6 were obtained under the same conditions as in FIG. 5.

When the fourth embodiment sample Emb-4 and the third comparison example Cmp-3 are compared in FIG. 6, it may be seen that the circumferential coercivity Hcc of the fourth embodiment sample Emb-4 is higher than that of the third comparison example Cmp-3. Further, while the orientation Hcc/Hcr for the third comparison example Cmp-3 is 1.08, the orientation Hcc/Hcr for the fourth embodiment sample Emb-4 is 1.09 and it may be seen that the orientation of the axes of easy magnetization is promoted in the circumferential direction for the fourth embodiment sample Emb-4. Accordingly, it may be seen that the orientation of the axes of easy magnetization of the recording layer 18 in the circumferential direction is further improved for the fourth embodiment sample Emb-4 which employs the inclined sputtering to form the seed layer 12, compared to that of the third comparison example Cmp-3, even though the mechanical texturing is provided on the substrate surface.

In addition, the SNR is also higher for the fourth embodiment sample Emb-4 when compared to the third comparison example Cmp-3. The SNR improves for the fourth embodiment sample Emb-4 due to the improved orientation of the axes of easy magnetization of the recording layer 18 in the circumferential direction, and as a result, a high recording density can be realized.

The embodiment samples described above use the underlayer 13 having the stacked structure, that is, a multi-layer structure, so as to further suppress the crystal grains of the underlayer 13 and the first and second magnetic layers 14 and 16 from becoming large, and to further improve the orientation ratio (OR) of the recording layer 18. However, the underlayer 13 is of course not limited to the stacked structure, and the effects of the present invention are similarly obtainable also when the underlayer 13 has a single-layer structure.

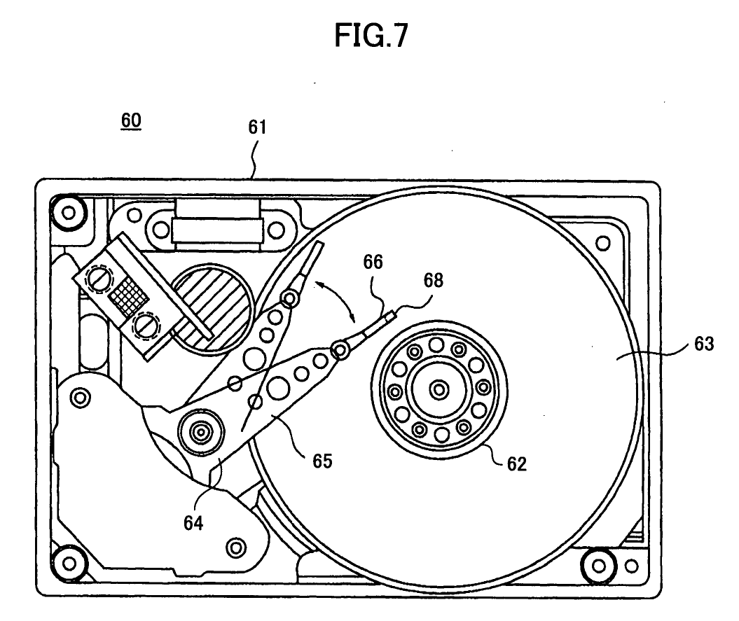

FIG. 7 is a plan view showing an important part of an embodiment of a magnetic storage apparatus according to the present invention.

As shown in FIG. 7, a magnetic storage apparatus 60 generally includes a housing 61. A hub 62, a plurality of magnetic recording media 63, an actuator unit 64, a plurality of arms 65, a plurality of suspensions 66, and a plurality of recording and reproducing heads (composite heads) 68 are provided within the housing 61. The magnetic recording media 63 are mounted on the hub 62 which is rotated by a motor (not shown). The recording and reproducing head 68 is made up of a reproducing head and a recording head. For example an Magneto-Resistive (MR) element, a Giant Magneto-Resistive (GMR) element, a Tunneling Magneto-Resistive (TMR) element such as a Current-In-Plane (CIP) element and a Current-Perpendicular-to-Plane (CPP) element, and the like may be used as the reproducing head. On the other hand, an inductive head such as a thin film head may be used for the recording head. Each recording and reproducing head 68 is mounted on the tip end of a corresponding arm 65 via the suspension 66. The arms 65 are moved by the actuator unit 64. The basic construction of this magnetic storage apparatus is known, and a detailed description thereof will be omitted in this specification.

The magnetic storage apparatus 60 is characterized by the magnetic recording media 63. Each of the magnetic recording media 63 has the stacked structure of the embodiment of the magnetic recording medium described above in conjunction with FIG. 1. In other words, each of the magnetic recording media 63 may have the structure of the magnetic recording medium 10 shown in FIG. 1, for example. Of course, the number of magnetic recording media 63 is not limited and one or more magnetic recording media 63 may be provided. In the case where the magnetic recording medium 63 has the disk-shape as shown in FIG. 7, the crystal orientation of the recording layer 18 in the circumferential direction and the SNR are improved, and a high recording density can be realized by the magnetic recording medium 63. Furthermore, by using the disk substrate 11 that is not textured, it is possible to reduce the surface roughness of the surface of the magnetic recording medium 63, to enable a floating distance of the recording and reproducing head 68 with respect to the surface of the magnetic recording medium 63 to be reduced, which in turn makes it possible to realize a higher recording density.

The basic construction of the magnetic storage apparatus is not limited to that shown in FIG. 7. The recording and reproducing head 68 is also not limited to that shown in FIG. 7, and suitable known heads may be used for the recording and reproducing head 68.

Because the magnetic recording medium 63 has the improved crystal orientation in the circumferential direction in the case of the magnetic disk, good static magnetic characteristics and improved SNR, the magnetic storage apparatus can carry out the recording at a high recording density.

In addition, the magnetic recording medium 63 used in the present invention is not limited to a magnetic disk. For example, the magnetic recording medium 63 may be a magnetic tape. When using the magnetic tape as the magnetic recording medium 63, the seed layer may be formed on a tape-shaped plastic film such as PET, PEN and polyamide films forming the substrate. In this case, the crystal orientation of the recording layer can be improved in the longitudinal direction of the tape-shaped film, by sputtering the particles of the seed layer from one of two sides of the tape (two edges of the tape on both sides along the width of the tape) at an angle that is inclined by a predetermined angle from a normal to the tape surface.

Further, the present invention is not limited to these embodiments, but various variations and modifications may be made without departing from the scope of the present invention.

What is claimed is:

1. A method of producing a magnetic recording medium having a recording layer that is magnetized in a recording direction to record information in the recording layer, comprising:
forming a seed layer, made of an amorphous CoW or an amorphous CoW alloy material, on a substrate surface;
forming an underlayer on the seed layer; and
forming the recording layer on the underlayer, said forming the seed layer comprising:
arranging a target to confront the substrate surface;
sputtering, with respect to the substrate surface, sputtering particles of the target from one of two sides partitioned by a first plane that is formed by the recording direction and a substrate normal which is normal to the substrate surface in a predetermined direction inclined with respect to the substrate normal; and
oxidizing a surface of the seed layer on which the underlayer is formed.

2. The method of producing the magnetic recording medium as claimed in claim 1, wherein said sputtering sputters the sputtering particles in the predetermined direction within a second plane which is approximately perpendicular to the first plane.

3. The method of producing the magnetic recording medium as claimed in claim 1, wherein the substrate has a disk-shape, and said sputtering sputters the sputtering particles in the predetermined direction from an outer peripheral side of the disk-shaped substrate relative to the first plane.

4. The method of producing the magnetic recording medium as claimed in claim 3, wherein the sputtering particles originate from an erosion region of the target, and said sputtering arranges the erosion region on an outer side of an outer peripheral edge of the disk-shaped substrate.

5. The method of producing the magnetic recording medium as claimed in claim 4, wherein said sputtering arranges the target and the disk-shaped substrate approximately coaxially, and the target has a ring-shape having an inner peripheral edge located on an outer side of the outer peripheral edge of the disk-shaped substrate.

6. The method of producing the magnetic recording medium as claimed in claim 3, wherein said sputtering includes:
preventing the sputtering particles sputtered with respect to the substrate surface from reaching a surface of the substrate opposite to the substrate surface when carrying out said sputtering,
said preventing using a shield part which confronts the substrate surface and has a shaft arranged approximately coaxially to an axis extending in a direction of the substrate normal and passing a center of the disk-shaped substrate, and a plurality of shield plates extending radially from the shaft and arranged at equal angular intervals along a circumferential direction of the disk-shaped substrate.

7. The method of producing the magnetic recording medium as claimed in claim 6, wherein said preventing rotates the shield part about the shaft.

8. The method of producing the magnetic recording medium as claimed in claim 3, further comprising:
texturing the substrate surface approximately in the recording direction prior to forming the seed layer.

9. The method of producing the magnetic recording medium as claimed in claim 1, wherein the seed layer is formed by CoW having a W-content of in a range of 30 at. % to 60 at. %.

10. The method of producing the magnetic recording medium as claimed in claim 1, wherein the underlayer is formed by Cr or a Cr-X alloy, where X=Mo, W, V, B, Mo or alloys thereof.

11. The method of producing the magnetic recording medium as claimed in claim 1, wherein the recording layer is formed by successively forming a first magnetic layer, a nonmagnetic spacer layer and a second magnetic layer on the underlayer, and magnetizations of the first and second magnetic layers are antiferromagnetically exchange-coupled via the nonmagnetic spacer layer.

12. A magnetic recording medium comprising:
a seed layer, made of an amorphous CoW or an amorphous CoW alloy material, provided on a substrate surface and having an oxidized surface;
an underlayer provided on the seed layer; and
a recording layer provided on the underlayer, said recording layer being magnetized in a recording direction to record information in the recording layer,
said seed layer being formed by crystal grains having an orientation inclined towards one of two sides partitioned by a plane that is formed by the recording direction and a substrate normal which is normal to the substrate surface.

13. The magnetic recording medium as claimed in claim 12, wherein the substrate has a disk-shape, and the crystal orientation of the crystal grains are inclined in an outer peripheral side of the disk-shape.

14. The magnetic recording medium as claimed in claim 12, wherein the seed layer is formed by the steps of:
arranging a target to confront the substrate surface;
sputtering, with respect to the substrate surface, sputtering particles of the target from one of two sides partitioned by said plane in a predetermined direction inclined with respect to the substrate normal; and
oxidizing a surface of the seed layer to form the oxidized surface.

15. A magnetic storage apparatus comprising:
at least one magnetic recording medium; and
a head to record and/or reproduce information to and/or from the magnetic recording medium,
wherein the magnetic recording medium comprises a seed layer made of an amorphous CoW or an amorphous CoW alloy material provided on a substrate surface and having an oxidized surface, an underlayer provided on the seed layer, and a recording layer provided on the underlayer, said recording layer being magnetized in a recording direction to record information in the recording layer,
said seed layer being formed by crystal grains having an orientation inclined towards one of two sides partitioned by a plane that is formed by the recording direction and a substrate normal which is normal to the substrate surface.

16. The magnetic storage apparatus as claimed in claim 15, wherein the substrate of the magnetic recording medium has a disk-shape, and the crystal orientation of the crystal grains are inclined in an outer peripheral side of the disk-shape.

17. The magnetic recording medium as claimed in claim 15, wherein the seed layer of the magnetic recording medium is formed by the steps of:
arranging a target to confront the substrate surface;
sputtering, with respect to the substrate surface, sputtering particles of the target from one of two sides partitioned by said plane in a predetermined direction inclined with respect to the substrate normal; and
oxidizing a surface of the seed layer to form the oxidized surface.
